(19) United States
(12) Patent Application Publication
(10) Pub. No.: US 2014/0067476 A1
(43) Pub. Date: Mar. 6, 2014

(54) MARKETING DEVICE, MARKETING METHOD, PROGRAM AND RECORDING MEDIUM

(71) Applicant: Accenture Global Services Limited, Dublin (IE)

(72) Inventors: Kazunori Seki, Tokyo (JP); Taishi Miyao, Tokyo (JP); Yuma Yano, Tokyo (JP); Shu Toyoshima, Tokyo (JP)

(21) Appl. No.: 14/015,685

(22) Filed: Aug. 30, 2013

(30) Foreign Application Priority Data
Aug. 30, 2012 (JP) 2012-189676

(51) Int. Cl. G06Q 30/02

(52) U.S. Cl. CPC G06Q 30/0204
USPC 705/7.33

(57) ABSTRACT

A customer information collection means collects sales information from POS data of a customer, and creates customer count data associating the collected sales information with personal information of the customer. A segmentation analysis means clusters the customer into a segment per lifestyle of the customer via k-means and Ward on the basis of the customer count data. A classification rule creation means creates a rule for uniquely deciding a segment from customer information via a decision tree analysis on the basis of a segment calculation result. A factor analysis means makes a factor analysis of a sales rate of segment-based customer count data, and extracts a characteristic factor indicating a characteristic of a product as a product characteristic/customer characteristic per product group.

### TECHNICAL FIELD

The present invention relates to a marketing device, a marketing method, a program and a recording medium, and particularly to a marketing device for segmenting customers based on POS data, a marketing method, a program and a recording medium.

### BACKGROUND ART

Analyses of customers or products have been conventionally made by use of POS (Point Of Sale system). For the POS, ID-POS using IDs (Identification) of point cards or the like when counting sales of products per product has been widely used. The ID-POS is used so that information on relationships between demographic attribute data of customers such as sex, age, residential area, income, occupation, educational background and family structure (hereinafter, referred to as demographic data), and purchase of products can be obtained.

As a conventional system utilizing POS data, there is disclosed in Patent Literature 1 a product information providing system comprising a purchased product information input unit for inputting information on purchase of products or services such as time/date, product, quantity, price and the like, a purchaser information input unit for specifying a purchaser, and a database for contents related to the products, the system performing information processing of searching and combining information related to a purchased product from the database based on the purchased product information, and transmitting the information to a customer information terminal (hereinafter, referred to as conventional technique 1). In the conventional technique 1, a customer can freely view information related to his/her purchased products. Further, applied use of purchased product information from a POS terminal or the like used for sales management in a retail store or the like is enabled.
Patent Document 1: Japanese Unexamined Patent Application, Publication No. H11-096214

### DISCLOSURE OF THE INVENTION

### Problems to be Solved by the Invention

However, the conventional POS data analyses including the conventional technique 1 have used only demographic information to classify segments. Thus, there has been a problem that analyzed POS data cannot be efficiently used for sales, development or the like of products.

The present invention has been made in terms of such a situation, and its object is to solve the above problem.

### Means for Solving the Problems

A marketing device according to the present invention comprises a customer information collection means for collecting POS data of a customer, and creating customer count data associating sales information contained in the collected POS data of the customer with personal information of the customer, and a segmentation analysis means for clustering the customer into a segment per lifestyle of the customer via non-hierarchy clustering and hierarchy clustering on the basis of the customer count data. The marketing device according to the present invention is configured such that the segmentation analysis means uses k-means as the non-hierarchy clustering to make a classification into a first number of types of the segments in the first stage, and uses Ward as the hierarchy clustering to further classify the first number of types of the classified segments into a second number of types of the segments less than the first number of types in the second stage. The marketing device according to the present invention comprises a factor analysis means for calculating a purchase rate in a product group of a product purchased by each customer per segment, makes a factor analysis of a sales rate per segment, which is calculated based on the purchase rate, and extracts a characteristic factor indicating a characteristic of a product as a product characteristic and a customer characteristic per product group. The marketing device according to the present invention comprises an attribute development means for adding attribute parameters corresponding to the product characteristic to product data to create a product characteristic master, and counting and creating a segment characteristic from the product characteristic master and the customer characteristic. The marketing device according to the present invention comprises a marketing suggestion means for calculating a marketing measure reaction rate, mROI (Marketing Return On Investment) or a store-based customer pattern by use of any of the product characteristic, the customer characteristic, the product characteristic master, and the segment characteristic. The marketing device according to the present invention is configured such that the segmentation analysis means uses the segment characteristic to perform re-segmentation. A marketing method according to the present invention is performed by a computer, the computer performing a step of collecting POS data of a customer and creating customer count data associating sales information contained in the collected POS data of the customer with personal information of the customer, and a step of clustering the customer into a segment per lifestyle of the customer via non-hierarchy clustering and hierarchy clustering on the basis of the customer count data. A program according to the present invention causes a computer to function as a customer information collection means for collecting POS data of a customer and creating customer count data associating sales information contained in the collected POS data of the customer with personal information of the customer, and a segmentation analysis means for clustering the customer into a segment per lifestyle of the customer via non-hierarchy clustering and hierarchy clustering on the basis of the customer count data. A recording medium according to the present invention is a computer readable recording medium recording a program therein, the program causing a computer to function as a customer information collection means for collecting POS data of a customer and creating customer count data associating sales information contained in the collected POS data of the customer with personal information of the customer, and a segmentation analysis means for clustering the customer into a segment per lifestyle of the customer via non-hierarchy clustering and hierarchy clustering on the basis of the customer count data.

### Effects of the Invention

According to the present invention, there can be provided a marketing device capable of performing segmentation on lifestyle attributes influencing product selling or preference for efficient use in sales or development of products.

### BRIEF DESCRIPTION OF THE DRAWINGS

FIG. 1 is a system configuration diagram of a marketing system X according to an embodiment of the present invention.

FIG. 2 is a block diagram illustrating a control configuration of an analysis server 10 according to the embodiment of the present invention.

FIG. 3 is a conceptual diagram of a data structure of a database 117 according to the embodiment of the present invention.

FIG. 4 is a flowchart of marketing processing according to the embodiment of the present invention.

FIG. 5 is a conceptual diagram illustrating segmentation processing according to the embodiment of the present invention.

FIG. 6 is a conceptual diagram illustrating classification rule creation processing according to the embodiment of the present invention.

FIG. 7 is a conceptual diagram illustrating a relationship between a segment purchase amount count processing and a factor analysis processing according to the embodiment of the present invention.

FIG. 8 is a conceptual diagram illustrating details of factor analysis processing according to the embodiment of the present invention.

FIG. 9 is a conceptual diagram illustrating attribute development processing according to the embodiment of the present invention.

FIG. 10 is a conceptual diagram illustrating exemplary product characteristic masters and exemplary segment characteristics according to the embodiment of the present invention.

FIG. 11 is a conceptual diagram illustrating re-segmentation according to the embodiment of the present invention.

FIG. 12 is a conceptual diagram illustrating exemplary analyses in combination of customer characteristics and individual product characteristics according to the embodiment of the present invention.

### PREFERRED MODE FOR CARRYING OUT THE INVENTION

### Embodiment

### [Structure of Marketing System X]

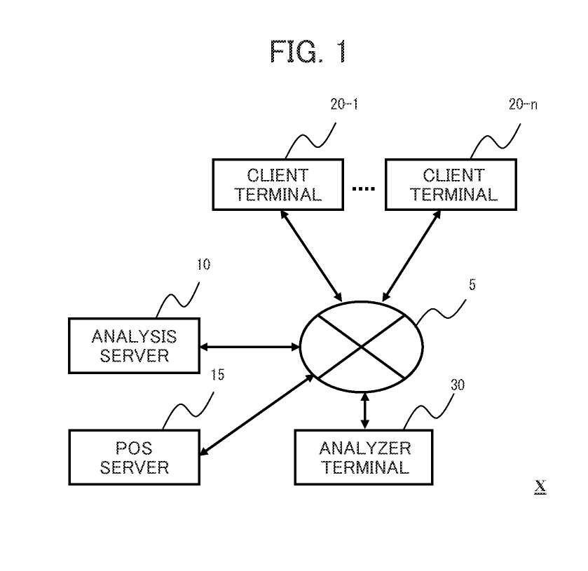

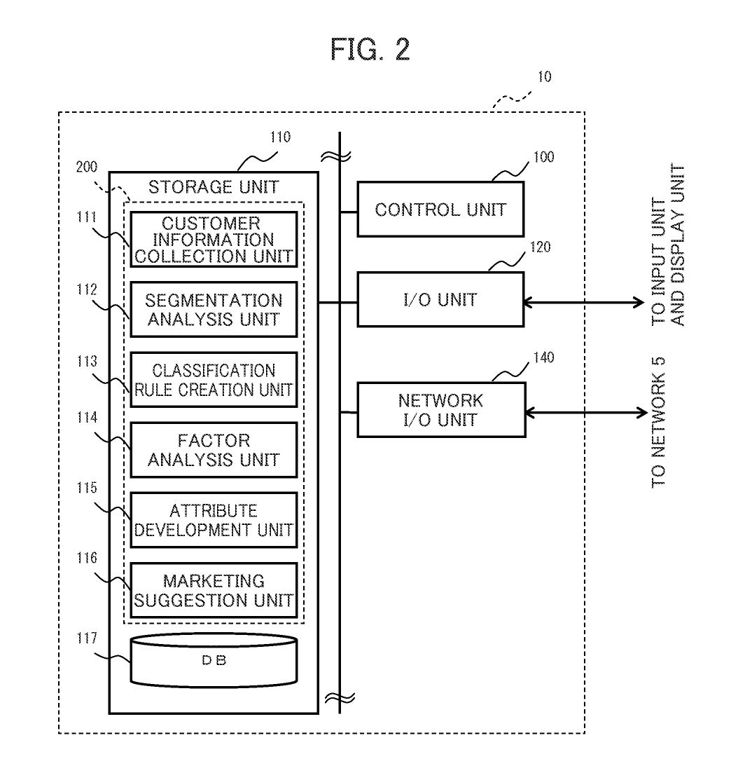

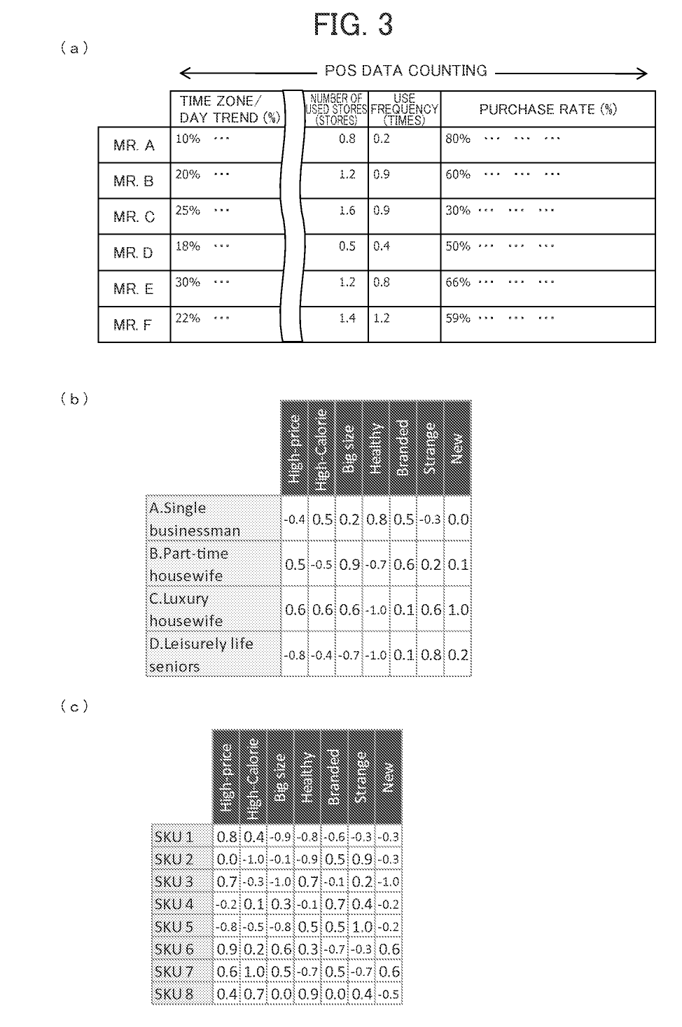

A structure of a marketing system X according to an embodiment of the present invention will be described below with reference to FIG. 1. A network 5 is a wide area network such as a dedicated line or the Internet, a wireless telephone network, LAN (Local Area Network), or the like. An analysis server 10 (marketing device, computer) is a server such as a PC/AT compatible machine or general-purpose machine for storing POS data from a POS server 15 in a database 117 (FIG. 2) and performing marketing processing (FIG. 3). The analysis server 10 also provides an interface for accessing, via WWW (World Wide Web), analysis results and the like output by executing each program contained in a customer/product characteristic analysis unit 200 by a control unit 100. A detailed structure of the analysis server 10 will be described below. The POS server 15 is a database server such as a PC/AT compatible machine or general-purpose machine. The POS server 15 receives and stores ID-POS data from client terminals 20-1 to 20-n, for example. Further, the POS server 15 stores customers' personal information associated with point cards and the like, and can store the customer IDs and the sales amounts in an associated manner. The client terminals 20-1 to 20-n are each a POS register, a server for in-store counting, or the like. The client terminals 20-1 to 20-n each acquire sales information containing time/date, location (area, store), type, sales amount, coupon/discount information of product purchase, and customer ID, and transmit them to the POS server 15. For example, information in stock keeping unit (SKU) in which information on size/color is different for a shirt can be used for “product.”

An analyzer terminal 30 is a terminal such as analyzer's PC/AT compatible machine or Smartphone for instructing the analysis server 10 to analyze the POS data. An analyzer uses the analyzer terminal 30 to log in and access the analysis server 10 thereby to set and instruct to execute various parameters of the customer/product characteristic analysis unit 200. Further, the analyzer can use the analyzer terminal 30 to perform various settings on the analysis server 10 in a management mode. Note that, the analysis server 10 or the POS server 15 may be configured of a plurality of servers or the like on so-called “Cloud.”

### (Structure of Analysis Server 10)

Next, a structure of the analysis server 10 will be described below with reference to FIG. 2. The analysis server 10 mainly comprises the control unit 100, a storage unit 110, an I/O unit 120 and a network I/O unit 140.

The control unit 100 is a control means comprising calculation and control capabilities such as CPU (Central Processing Unit), MPU (Micro Processing Unit), DSP (Digital Signal Processor), GPU (Graphics Processing Unit) or ASIC (Application Specific Processor). The control unit 100 uses hardware resources to execute each program of the customer/product characteristic analysis unit 200 on the basis of the data in the database 117 stored in the storage unit 110, or the like. At this time, the control unit 100 may comprise an accelerator capable of rapidly performing statistical numeric operations, and the like. The storage unit 110 is a storage means such as a flash memory disk including RAM (Random Access Memory) or SSD (Solid State Drive), HDD (Hard Disk Drive), a magnetic tape device, or an optical disk device. The storage unit 110 stores therein the customer/product characteristic analysis unit 200 as a group of programs including a customer information collection unit 111 as a program for causing the analysis server to function as a customer information collection means, a segmentation analysis unit 112 as a program for causing the analysis server to function as a segmentation analysis means, a classification rule creation unit 113 as a program for causing the analysis server to function as a classification rule creation means, a factor analysis unit 114 as a program for causing the analysis server to function as a factor analysis means, an attribute development unit 115 as a program for causing the analysis server to function as an attribute development means, and a marketing suggestion unit 116 as a program for causing the analysis server to function as a marketing suggestion means, and various items of data. Herein, the control unit 100 executes the customer/product characteristic analysis unit 200 as the group of programs to cause the analysis server to function as predetermined means (hereinafter, named generically as “customer/product characteristic analysis means”). In addition, the storage unit 110 stores programs and data of OS (Operating System), other application software and WWW servers or the like for causing the analysis server 10 as a computer. The programs and data are executed or are readable/writable by the control unit 100. The I/O unit 120 is a component for providing an interface of DVI, analog RGB, HDMI, USB, IEEE1394, serial, parallel, infrared, wireless or the like, which is directed for connecting to various peripheral devices. The I/O unit 120 can be connected to an input unit such as keyboard or mouse for performing various settings of the analysis server 10 or setting the customer/product characteristic analysis unit 200, or the like, and a display unit such as LCD display. The network I/O unit 140 is a standard LAN interface such as 1000 BASE-T for connecting to the network 5. Note that, the network I/O unit 140 may be connected to an external hub, router, load balancer or the like. Note that, the analysis server 10 may not comprise the network I/O unit 140. In this case, the analysis server 10 can transfer programs or data from an external storage medium to the storage unit 110, and can analyze POS data by use of the customer/product characteristic analysis means in a so-called “standalone” manner.

The storage unit 110 comprises the customer/product characteristic analysis unit 200 and the database 117. The customer/product characteristic analysis unit 200 stores therein programs, data and the like executed as various means by the control unit 100 by use of the hardware resources. The database 117 is a database capable of being constructed by use of mySQL, Microsoft (trademark) SQL or the like. The customer/product characteristic analysis unit 200 can be provided and installed as a program stored in the recording medium.

The customer information collection means collects various items of sales information including a purchase history such as a predetermined number of samples of customer receipt data at least enough for analysis from the customer ID-POS data. Then, the customer information collection means calculates a sales rate, a time zone/day trend, a used store rate, and the like from the collected sales information. Thereby, the customer information collection means creates customer count data (see FIG. 3(a)) as POS data counted in association with the customer information per customer, and stores the same in the database 117. The segmentation analysis means clusters each customer into a segment per customer lifestyle on the basis of the customer count data. The clustering may use various hierarchy/non-hierarchy clustering, and particularly, preferably uses a combination of k-means and Ward. The classification rule creation means is directed for creating a rule for uniquely deciding a segment from the customer count data by various artificial intelligence/statistical methods on the basis of segment results by the segmentation analysis means. It is suitable that the rule employs a decision tree for the artificial intelligence means, for example. A model based on neural net or Bayes' statistics may be created and used. The factor analysis means analyzes the factors of the product sales rate in the customer count data per segment, and extracts a characteristic factor indicating a product characteristic as a product characteristic/customer characteristic per product group. Specifically, the factor analysis means calculates a purchase rate per product classification of each segment, assumes a correlation value as a distance, and projects it into a multidimensional space, thereby making a principal component analysis and determining axes. It is suitable that a four-dimensional space as the multidimensional space is used for mapping, for example. The attribute development means adds attribute parameters corresponding to the extracted product characteristics to all the products to create a product characteristic masters, and counts and creates segment characteristics from the attribute parameters corresponding to the product characteristics and the customer characteristics, which are stored in the database 117. The marketing suggestion means calculates a marketing measure reaction rate, mROI (Marketing Return On Investment), a store-based customer pattern, and the like on the basis of the extracted product characteristics, customer characteristics, product characteristic masters, and segment characteristics. That is, the marketing suggestion means makes a mROI analysis, calculates indexes for suggesting product development, and suggests a rule for reducing loss of sales opportunity/loss of discard, thereby providing a user interface therefor.

The database 117 is a SQL database storing various items of data therein, or the like. The database 117 can store the sales information data of the ID-POS or the customer count data acquired from the POS server 15, for example. The database 117 also stores each item of data of the product characteristics, the customer characteristics, the product characteristic masters, the segment characteristics, and the like. A structure of the each item of data will be described below in detail.

### (Structure of Database 117)

An exemplary structure of the database 117 will be described herein with reference to FIG. 3. FIG. 3(a) illustrates exemplary customer count data as counted POS data per customer. Herein, the longitudinal axis indicates each customer and the horizontal axis indicates a POS data count value. The customer count data stores therein purchase time zone/day trend, number of used stores, use frequency, purchase rate, and the like as the count values. The purchase rate stores a purchase rate according to a predetermined product classification of each purchased product. The predetermined product classification can be changed per type of POS data to be analyzed, and can employ classifications such as foods, sweets, cigarettes, daily items and others in a case of a convenience store. Further, the purchase rate can store a rate between a purchased SKU, and a money amount and purchase quantity, or the like. FIG. 3(b) illustrates exemplary customer characteristics (lifestyle attributes) calculated by the factor analysis means. In FIG. 3(b), the longitudinal axis indicates a segment and the horizontal axis indicates an exemplary factor. The numerals indicate “factor score”, where a positive number indicates a higher preference and a negative number indicates a lower preference. The factor score can be found from distances of the perpendicular line to the axes obtained by the factor analysis means. FIG. 3(c) illustrates exemplary product characteristics calculated by the factor analysis means. In this example, the longitudinal axis indicates SKU for each product and the horizontal axis indicates an exemplary factor. Also for the product characteristics, each numeral indicates a factor score, +/− indicates high/low of a preference. The factor score of the product characteristic can be found from distances of the perpendicular line to the axes. Note that, calculation of the product characteristic master, the segment characteristic and each item of data stored in the database 117 will be described below in detail.

### [Marketing Processing of Analysis Server 10]

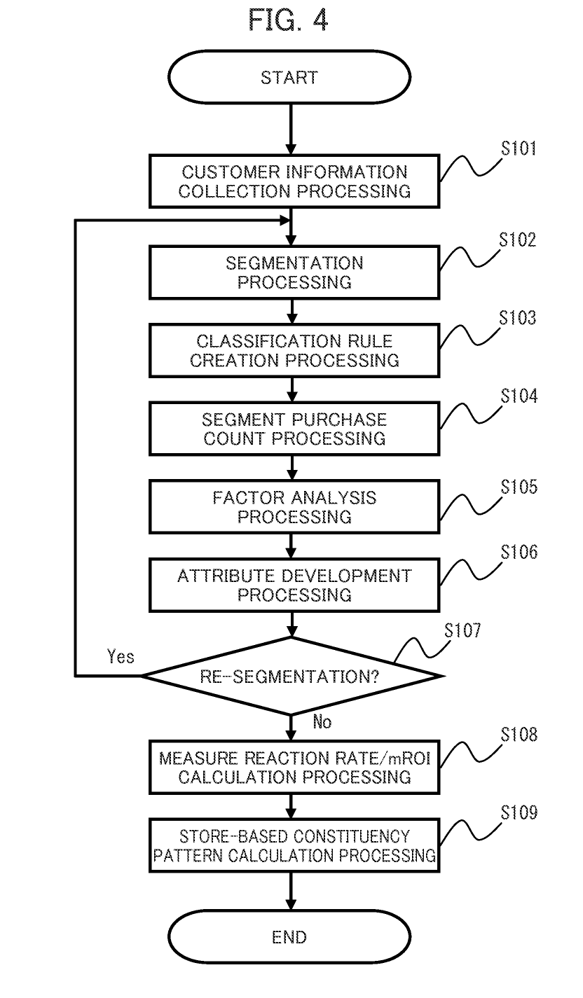

Next, the marketing processing of the analysis server 10 will be described below in detail with reference to FIGS. 4 to 12. In the marketing processing, the analysis server 10 first acquires ID-POS data of samples and creates customer count data according to the set parameters. Then, the analysis server 10 performs customer segmentation according to the set parameters and predetermined indexes from the customer count data. Thereafter, the analysis server 10 sums the purchase amount per segment, makes a factor analysis and calculates the customer characteristics and the product characteristics according to the set parameters. Finally, the analysis server 10 adds the acquired customer characteristics and product characteristics to the data on all the products and the segments, thereby to create product characteristic masters and segment characteristics. Thereafter, the acquired customer characteristics and product characteristics are used to perform segmentation again or to find a marketing measure reaction rate or mROI. Thereby, a customer segment classification is made in terms of “lifestyle” in addition to a conventional POS data analysis using demographic information, thereby obtaining POS data analysis information needed for customer's view point. Further, the product characteristic master is created in consideration of lifestyle-based preference, thereby implementing efforts for more effective marketing. The marketing processing according to the embodiment of the present invention will be described below in detail per step with reference to the flowchart of FIG. 4.

### (Step S101)

At first, the analysis server 10 performs customer information collection processing by the customer information collection means. In the processing, the customer information collection means randomly extracts and acquires ID-POS data including a predetermined number of samples such as sales information on more than 100,000 persons according to the set parameters from the POS server 15. Specifically, the customer information collection means accesses the POS server 15 from the network I/O unit 140 via the network 5, and acquires ID-POS data in a predetermined format. Thereby, the customer information collection means stores the acquired ID-POS data in each customer unit as customer count data in the database 117. The counting is performed on time zone/day trend, used store, use frequency, purchase rate, other predetermined indexes, and the like. That is, the customer information collection means collects the values in association with each person's lifestyle such as purchase contents, time and frequency from data such as receipt of a customer having an ID-POS-recorded member card (hereinafter, referred to as customer data).

With a more specific description, the customer information collection means counts various count values according to the predetermined indexes described above for use in segmentation described below. Exemplary counting employs the following values. For time zone trend, the customer information collection means counts the number of individual days in a purchase history per time zone. As the division of the time zone, for example, the values of morning (5:00 to 10:00), lunch hours (11:30 to 14:00), daytime (10:00 to 11:30, 14:00 to 17:00), evening (17:00 to 22:00), nighttime (22:00 to 25:00) and small hours (25:00 to 29:00) are employed. Further, purchases in the same time zone on the same day can be counted as one. For day trend, the customer information collection means counts the number of days when purchase is performed on holidays/weekdays. Specifically, the number of holidays for purchase and the number of weekdays for purchase are counted. At this time, the holidays include weekends and national holidays. For used store, the customer information collection means counts the number and the rate of mainly used stores. At this time, the control unit 100 counts the number of purchase stores, a rate of the most-frequently used store, a rate of the second most-frequently used store, a rate of the third most-frequently used store, and the like in the latest 15 histories. For use frequency, the customer information collection means counts a frequency of use (purchase) days. At this time, assuming that the days one week before and after the purchase day are purchasable days, a rate of purchase days in the period is counted. For purchase rate, the customer information collection means counts a purchase rate and purchase contents according to predetermined product classifications. The predetermined product classifications employ foods (meals), sweets, cigarettes, daily items and others in a case of a convenience store as described above. For other details, the customer information collection means can make a count based on POS data type or analysis target according to the set parameters. For example, in a case of a convenience store, it is possible to count quality of food, amount of purchased healthy food/food purchase day, amount of purchased junk food/food purchase day, holiday's meal discrimination, amount of purchased holiday's food, and the like.

### (Step S102)

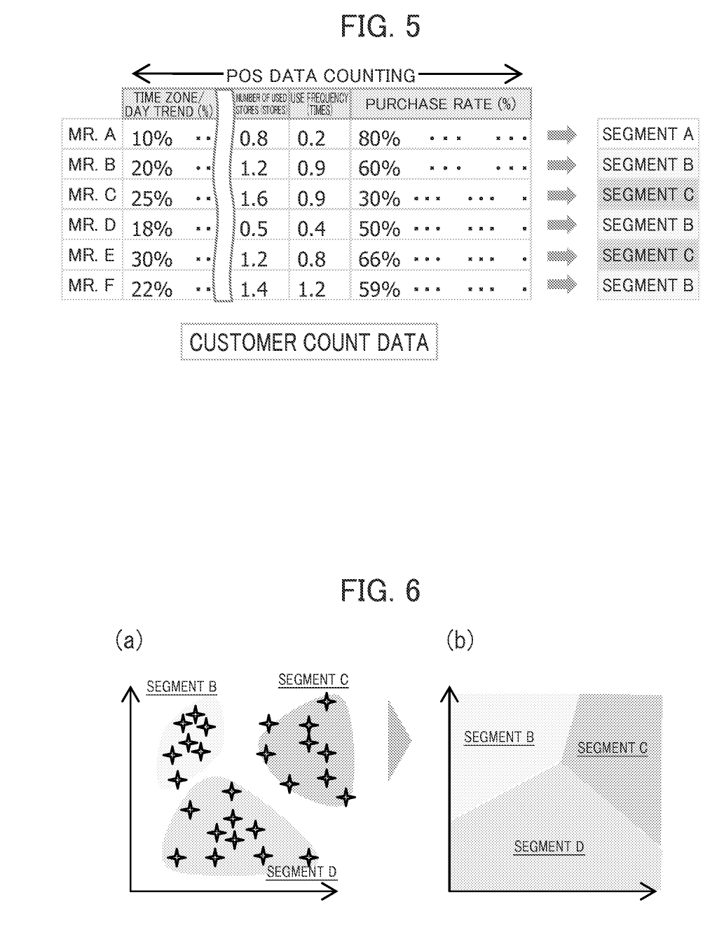

Next, the analysis server performs the segmentation processing by the segmentation analysis means. With reference to FIG. 5, in the processing, the segmentation analysis means performs segmentation from the customer count data in order to decide attribute characteristics/product characteristics. Specifically, the segmentation analysis means performs two-stage clustering from the customer count data containing about 100,000 items of customer data as the number of samples according to the set parameters. Then, the segmentation analysis means finally classifies the customers into about 20 “segments” per lifestyle on the basis of the customer information. At first, for the first-stage clustering, the segmentation analysis means calculates a similarity of each value of the predetermined indexes, and uses the similarity to first make a classification into a first number of types of segments by k-means which is non-hierarchy clustering, for example. The first number of types of segments classified by k-means is not particularly limited, but is preferably about 50 to 200, and more preferably about 100. Further, for the second-stage clustering, the segmentation analysis means uses Ward which is hierarchy clustering, for example, to further classify the segments classified into about 50 to 200 described above into a second number of types of segments. The second number of types of segments classified by Ward is not particularly limited if it is less than the first number of types, but is preferably about 20 to 30, and more preferably about 24 to 27 types. That is, it is preferable to make a classification into segments indicating about 24 to 27 similar trends with Ward. For the classified segments, the manager can decide a name of segment A, which is considered as corresponding to customer information and lifestyle, as a label such as “Single businessman” via the analyzer terminal 30, the I/O unit 120 or the like.

Note that, for the clustering, it is suitable that the number of samples is not reduced and a predetermined number of samples such as 100,000 persons are to be analyzed. Thereby, a customer with a low purchase frequency can be in a different segment from a customer with a high purchase frequency, thereby performing more accurate clustering. After the product attributes are analyzed in this way, the segmentation analysis is made on the customers with rough product categories only, thereby coping with a convenience store having a small number of products, or the like. Furthermore, as described below, the acquired customer characteristics/product characteristics are used to further repeat segmentation. Thereby, segmentation more suitable to the customer/product characteristics can be performed.

### (Step S103)

Next, the analysis server performs the classification rule creation processing according to the set parameters by the classification rule creation means. With a description with reference to FIG. 6, the classification rule creation means makes a decision tree analysis, for example, based on the calculated segments, and creates a rule for uniquely deciding which segment a customer is classified into. That is, as in FIG. 6(a), in the above-described segmentation processing, the customer count data is only classified and the classification rule is not created. To the contrary, as in FIG. 6(b), for example, a decision tree is used thereby to create a rule for explaining a classification result. For the decision tree rule creation, the classification rule creation means preferably creates a rule with an accuracy of about 90% in order to avoid over-fitting and the like. Note that, when an accuracy does not increase even with a predetermined number of rules, or the like, a decision tree can be re-created on re-segmentation.

### (Step S104)

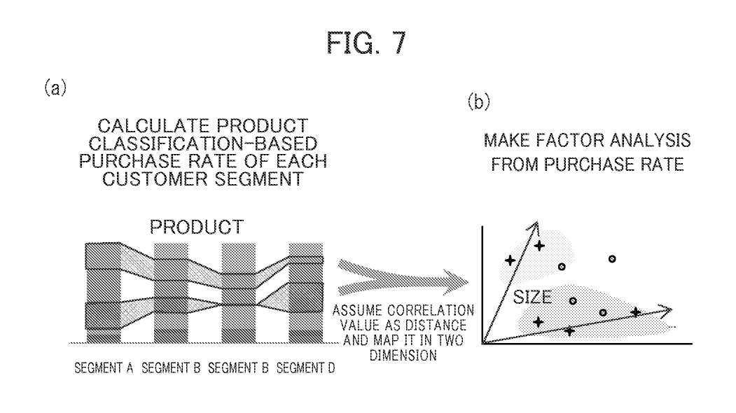

Next, the analysis server performs the segment purchase count processing according to the set parameters by the factor analysis means. With a description with reference to FIG. 7(a), at first, the factor analysis means calculates a product purchase rate per product group from the customer data per segment. In the processing, the factor analysis means uses predetermined product groups used in marketing, such as soft drink, liquor, rice and bread for foods in a convenience store, for example. That is, for example, there are configured such that the soft drink product group contains each SKU of product A, product B and product C, and the rice product group contains each SKU of product D and product E, for example. Thereby, with a factor analysis described later, the disadvantage that the customer characteristics/product characteristics cannot be directly extracted per SKU of all the products because of the characteristics of the factor analysis method can be overcome.

### (Step S105)

Next, the factor analysis means performs the factor analysis processing. At first, with a description with reference to FIG. 7(b), the factor analysis means assumes a correlation value for a product purchase rate per product group as a distance according to the set parameters, and maps it in a two-dimensional space thereby to make a factor analysis. In the processing, the factor analysis means makes a factor analysis of a product sales rate per segment, and extracts two to four characteristic factors indicating the characteristics of a product per product group.

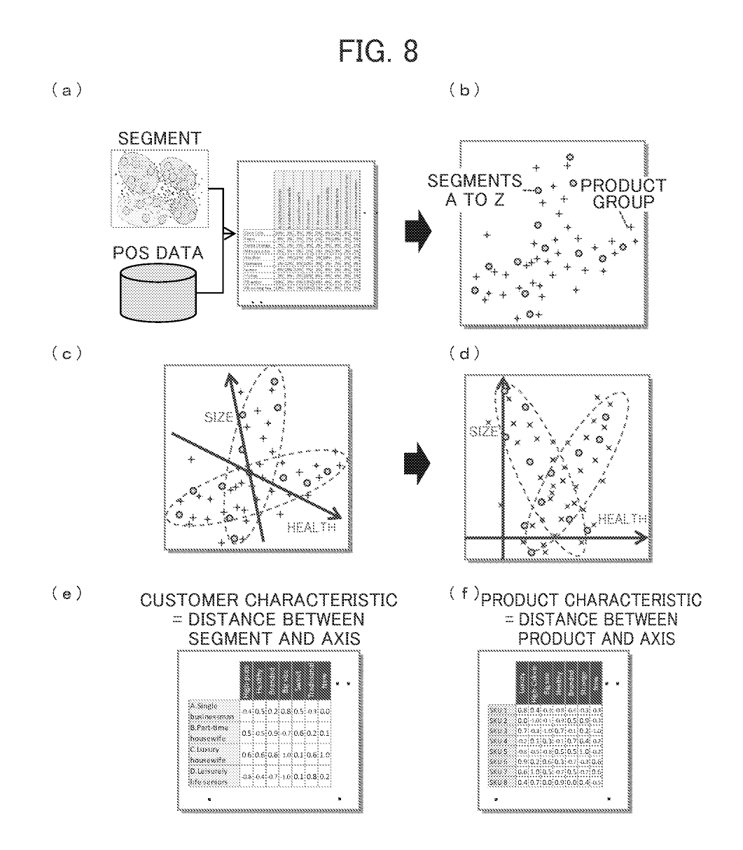

The factor analysis processing will be described herein in detail with reference to FIG. 8. At first, in FIG. 8(a), the factor analysis means calculates a purchase rate in a product group of a product purchased by each customer in each segment from the customer count data, thereby obtaining a correlation value as described above. Next, in FIG. 8(b), the factor analysis means draws, in a four-dimensional space with any four axes among the predetermined indexes described above, an average value of the correlation values of the values of the segments and a correlation value of each product group as each point. FIG. 8(b) is a figure in which the four-dimensional space is projected in two dimension, which is arbitrarily rotatable. In the figure, the average value of the correlation values of the segments is indicated with 0 and the correlation value of the product group is indicated with +.

Next, in FIG. 8(c), the factor analysis means makes a principal component analysis and decides axes for at least two factors. Specifically, for a relationship between each point of each product group and each segment, the principal component analysis is made to set axes. The principal component analysis can be realized by use of Princomp function of statistical analysis software SAS of SAS company, or the like, for example. Note that, there may be employed a method for selecting axes from a higher-dimensional space of all the predetermined indexes by use of not the four-dimensional space but the kernel method. Next, in FIG. 8(d), the factor analysis means arbitrarily rotates the axes obtained by the principal component analysis and converts them into the Cartesian coordinate system according to an execution instruction. Further, the factor analysis means sets the factor names such as “size” and “health” for a relationship between each axis converted into the Cartesian coordinate system and a product, for example. The factor names may be set with a predetermined name as a label, or may be set by the manager via the analyzer terminal 30 or the I/O unit 120. Thereby, the customer characteristics/product characteristics of each factor can be extracted. Note that, the manager can visually rotate the axis freely. Next, in FIG. 8(e), the factor analysis means calculates a temporary segment characteristic based on a height (distance) of the perpendicular line from each segment point to each axis. The temporary segment characteristic can be calculated in a form of a table where the longitudinal axis indicates each segment and the horizontal axis indicates each factor, for example. The numerals in the table are factor scores of the attribute parameters reflecting a degree of preference with + and −. A final segment characteristic is calculated from the temporary segment characteristic in the attribute development processing described below. Next, in FIG. 8(e), the factor analysis means calculates a product characteristic based on a height (distance) of the perpendicular line from each product group point to each axis. The product characteristic can be calculated in a form of a table where the longitudinal axis indicates SKU of each product group and the horizontal axis indicates each factor, for example. In this stage, a value of each corresponding product group can be copied for use per SKU.

### (Step S106)

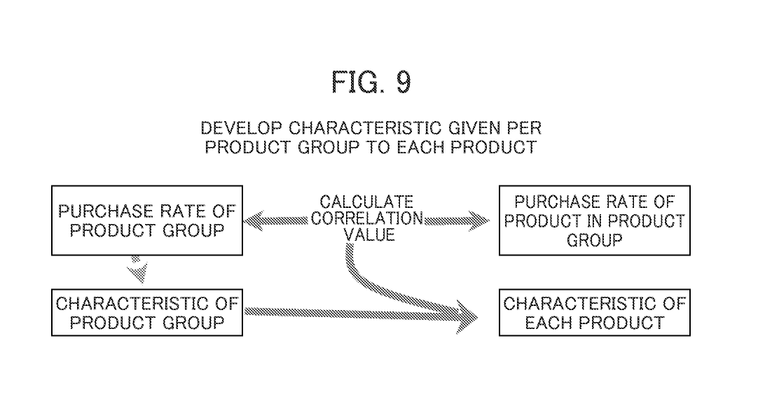

Next, the analysis server performs the attribute development processing by the attribute development means. In the processing, the attribute development means first gives the extracted product characteristic to each SKU in a group and re-counts the product characteristic of each SKU into a product group to which the SKU belongs. Then, the attribute development means stores the re-counted product characteristics of all the product groups as product characteristic masters in the database 117. With a description with reference to FIG. 9, the attribute development means calculates a correlation value between a purchase rate of each SKU in a product group and a purchase rate of a product in the product group based on the product characteristics temporarily extracted per product group. The control unit 100 assigns a product characteristic of each product group to each SKU according to a magnitude of the correlation value. Thereby, the attribute development means can calculate the product characteristic of each product as a product characteristic master.

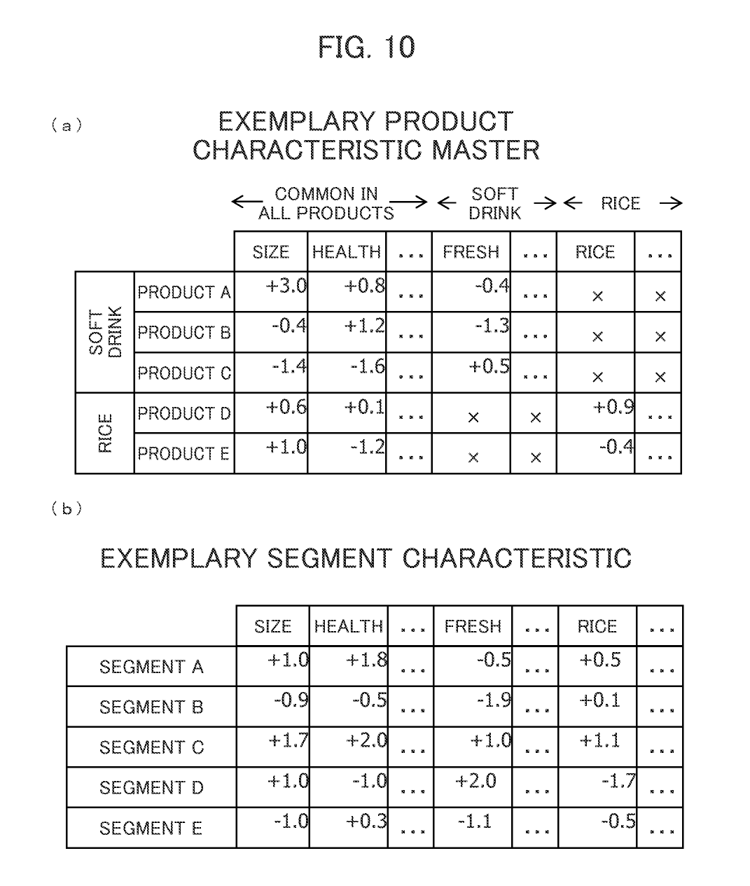

Exemplary product characteristic masters will be described with reference to FIG. 10(a). In this example, the longitudinal axis indicates each product and the horizontal axis indicates each factor. In this example, each product is grouped in units of product group such as soft drink or rice. Further, each factor can be arranged in order from “total” such as common in all products, for soft drink or for rice to “product group unit”. The values in the table indicate factor scores of the same attribute parameters as the temporary segment characteristics or product characteristics described above. A larger value of the factor score indicates a higher preference of the characteristic. That is, as a value of the factor score is higher, the factor is more desired in the product. Further, a negative value of the factor score indicates a contrary preference. Note that, there are some factor scores which are not given depending on products. In addition, in the example of FIG. 10(a), the product is set to be the same as SKU.

Thereafter, the attribute development means uses the product characteristic of each SKU of the product characteristic master to calculate a factor score of each customer from the temporary segment characteristic like the above product characteristic master, thereby calculating the customer characteristic of each customer. The attribute development means counts the factor scores of each segment from the modified customer characteristics of each customer and stores it as an official segment characteristic in the database 117.

Exemplary segment characteristics will be described with reference to FIG. 10(b). The segment characteristic is indicated in a table where the longitudinal axis indicates each segment and the horizontal axis indicates each factor like the above temporary segment characteristic. For the segment characteristic, the same factors as the product characteristic master are preferably used. Thereby, a relationship between the product characteristic and the segment can be easily grasped. In addition, in the segment characteristic, each value indicates an attribute parameter factor score. That is, as a value of the factor score is higher, a product with the higher preference is easily purchased. On the contrary, as a value of the factor score is lower, a product with a contrary preference is difficult to be purchased. Note that, the attribute development means sets all the factor scores in the table for the segment characteristics.

### (Step S107)

Next, the analysis server decides whether re-segmentation is necessary. Herein, the analysis server uses the obtained product characteristic master and segment characteristic to decide whether to perform re-segmentation on each customer. The analysis server decides Yes when the manager has set re-segmentation or an accuracy in the decision tree analysis described above is low. Otherwise, the analysis server decides No. In the case of Yes, the analysis server returns the processing to step S102, where it uses the obtained product characteristic master and segment characteristic to perform segmentation or make a decision tree analysis again. In the case of No, the analysis server proceeds to step S108.

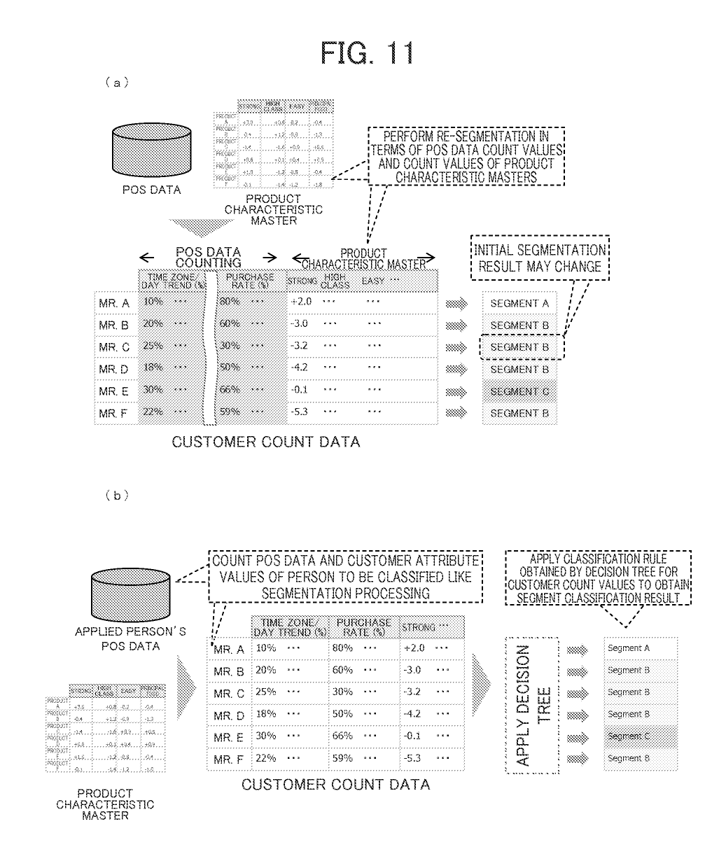

The processing on the re-segmentation will be described with reference to FIG. 11. FIG. 11(a) illustrates an example in which the calculated factor scores of the segment characteristics are added to the customer count data to perform re-segmentation. The segmentation is performed like the above-described segmentation processing. Thereby, a segment to which each customer belongs may change. That is, segmentation more suitable for the lifestyle attributes can be performed. FIG. 11(b) illustrates an example in which the classification rule creation processing is performed again on each customer

Like the above-described re-segmentation, the product characteristic master is added to the customer count data to make a decision tree analysis. The classification rule obtained by the decision tree is applied thereby to obtain a more accurate segment classification result.

### (Step S108)

Then, the analysis server performs measure reaction rate/mROI calculation processing by the marketing suggestion means. Specifically, the marketing suggestion means can calculate mROI from the segment characteristic and the product characteristic master. That is, ROI (Return On Investment) for a relationship between the marketing measure return (R) and the investment (I) can be calculated from the marketing measure cost. That is, for example, a coupon for 10% reduction of a product is distributed, how much a customer in which segment purchases can be calculated, thereby calculating an investment interest. Thereby, a less effective discount or campaign can be avoided, thereby enhancing mROI. The marketing suggestion means can calculate a reactivity and mROI as analyses of the measure sensitivity per past marketing measure type. Thereby, which segment is to be targeted can be grasped per measure.

### (Step S109)

Next, the marketing suggestion means performs the store-based customer pattern calculation processing according to an execution instruction. Herein, the marketing suggestion means calculates and analyzes store-based constituency according to the execution instruction. That is, a rate of segment for visited customers is analyzed from the customer count data. Thereby, it is possible to grasp which segment contains more customers per store. The marketing suggestion means can grasp which product is more desirable per store on the basis of the segment structure ratio of the visited customers, thereby calculating a store-based recommended product according to the execution instruction.

The marketing suggestion means can also suggest a marketing measure from the product characteristic masters and the segment characteristics. At first, the marketing suggestion means scores an attribute parameter factor score per unit product (SKU) in a predetermined reference from the product characteristic master, thereby grasp what the product characteristic is in terms of a customer not in terms of development. Further, the marketing suggestion means can calculate basic information such as ratio of persons, ratio of sales, sex/age structure, time zone/day trend, main used store per segment as a segment's basic profile according to the execution instruction. The marketing suggestion means refers to the product characteristic master per segment as a segment-based preference according to the execution instruction, thereby estimating a relationship between a sold product and a product of each segment. The calculation of the segment-based preference will be described below. Further, the marketing suggestion means can calculate a product group with a higher preference according to the execution instruction. That is, for example, about 30 products with a higher/lower purchase rate than other segments can be extracted, thereby to suggest a new product group. The product group can be referred to when grasping the segment characteristics.

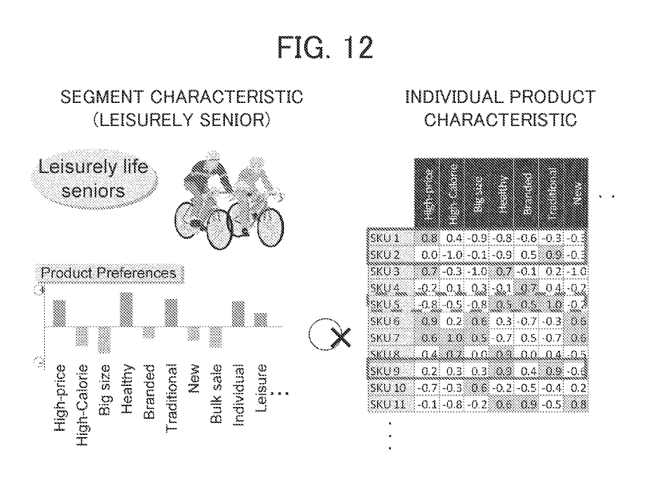

Here, the calculation of the segment-based preference will be described herein with reference to FIG. 12. Herein, a product ability per segment can be estimated with reference to the product characteristic master from the segment characteristics. The marketing suggestion means can first calculate a segment-based preference in a graph from the segment characteristics. For example, a “leisurely senior” segment in FIG. 12 (a) is such that “high-price” is popular and leisure-related products are popular. It can be seen that “traditional” and “healthy” products are popular and “high-calorie” or “big size” products are not popular. When the “leisurely senior” preference is scored per SKU from the product characteristic master, it can be seen that SKU 1, 2, and 9 are popular because of “high-price”, “healthy” and “traditional” in the example of FIG. 12. It can be seen that SKU 5 is “traditional” and thus may be popular. In this way, what kind of product characteristics there are can be grasped from a customer's view point separately from a view point of the development side. In addition, the marketing suggestion means can calculate product SKU with a high purchase-together for each of all the product SKUs. Further, the marketing suggestion means can calculate and indicate a product or segment with a high purchase-together rate. As described above, the marketing processing ends.

The following advantages can be obtained with the structure as described above. At first, the analysis server 10 according to the embodiment of the present invention can optimize and select campaign contents according to a lifestyle, thereby making use of them for product development. Further, the analysis server 10 can select optimum product/customer, thereby reducing loss of sales opportunity/loss of discard. In addition, the analysis server 10 can grasp a demand according to a store-based customer structure, thereby preventing a mismatch between supply and demand.

Note that, the structure and operations of the embodiment are exemplary, and of course may be changed and conducted as needed without departing from the scope of the present invention.

### INDUSTRIAL APPLICABILITY

According to the present invention, a marketing device capable of making clustering classifications of customers with a high accuracy can be provided and industrially applied.

### EXPLANATION OF REFERENCE NUMERALS

5: Network
10: Analysis server
15: POS server
20-1 to 20-n: Client terminal
30: Analyzer terminal
100: Control unit
110: Storage unit
111: Customer information collection unit
112: Segmentation analysis unit
113: Classification rule creation unit
114: Factor analysis unit
115: Attribute development unit
116: Marketing suggestion unit
117: Database
120: I/O unit
140: Network I/O unit
200: Customer/product characteristic analysis unit
X: Marketing system

1-9. (canceled)

10. A marketing data analysis system comprising:
a customer information collection unit configured to collect sales information from POS data of a customer, and create customer count data to associate the collected sales information of the customer with personal information of the customer; and
a segmentation analysis unit configured to:
cluster the customer into a segment per lifestyle of the customer via non-hierarchy clustering on the basis of the customer count data; and
further cluster the clustered customer via hierarchy clustering on the basis of the customer count data.

11. The data analysis system according to claim 10, wherein the segmentation analysis unit uses k-means clustering as the non-hierarchy clustering to make a classification into a first number of types of the segments in the first stage, and
uses Ward's method as the hierarchy clustering to further classify the first number of types of the classified segments into a second number of types of the segments less than the first number of types in the second stage.

12. The data analysis system according to claim 10, comprising:
a factor analysis unit configured to calculate a purchase rate in a product group of a product purchased by each customer per segment, making a factor analysis of a sales rate by segment, which is calculated based on the purchase rate, and extracting a characteristic factor indicating a characteristic of a product as a product characteristic and a customer characteristic.

13. The data analysis system according to claim 12, comprising:
an attribute development unit that attributes parameters corresponding to the product characteristic to product data to create a product characteristic master, and counting and creating a segment characteristic from the product characteristic master and the customer characteristic.

14. The data analysis system according to claim 13, comprising:
a marketing suggestion unit that calculates a marketing measure reaction rate, mROI (Marketing Return On Investment) or a store-based constituency pattern by use of any of the product characteristic, the customer characteristic, the product characteristic master and the segment characteristic.

15. The data analysis system according to claim 13, wherein the segmentation analysis unit uses the segment characteristic to perform re-segmentation.

16. A computer-implemented method comprising:
collecting sales information associated with customers regarding product purchases made by the customers and storing the sales information in a database;
clustering the customers into multiple customer segments based on the collected sales information;
calculating product purchase rates per product group for the multiple customer segments based on the collected sales information;
calculating a characteristic factor representing a correlation between a product characteristic and a customer characteristic based on the customer segments and the calculated product purchase rates;
storing the characteristic factor in the database in association with at least one product and at least one customer segment;
obtaining a target customer segment; and
suggesting a recommended product or recommended product group based on the stored characteristic factor and the obtained target customer segment.

17. The method of claim 16, wherein clustering the customers into multiple customer segments based on the collected sales information comprises:
clustering the customers into a first set of customer segments representing different lifestyles based on collected sales information using non-hierarchy clustering; and
clustering the customers into the multiple customer segments comprising a second set of fewer customer segments representing different lifestyles based on the clustered first set of customer segments using hierarchy clustering.

18. The method of claim 17, wherein clustering the customers into a first set of customer segments representing different lifestyles based on collected sales information using non-hierarchy clustering comprises:
classifying the customers into a first number of types of segments in a first stage using k-means clustering as the non-hierarchy clustering.

19. The method of claim 17, wherein clustering the customers into a second set of fewer customer segments representing different lifestyles based on the clustered first set of customer segments using hierarchy clustering comprises:
further classifying the first number of types of the classified segments into a second number of types of the segments less than the first number of types in the second stage using Ward's method as the hierarchy clustering.

20. The method of claim 16, comprising:
adding attribute parameters corresponding to the product characteristic to product data to create a product characteristic master including factor scores for the product characteristic for each product in the product group based on the calculated characteristic factor; and
counting and creating a segment characteristic including factor scores for the customer characteristic for each customer in a customer segment based on the product characteristic master and the calculated characteristic factor.

21. The method of claim 20, comprising performing re-clustering using the segment characteristic.

22. The method of claim 20, comprising:
calculating a marketing measure reaction rate, mROI (Marketing Return On Investment) or a store-based constituency pattern by use of any of the product characteristic, the customer characteristic, the product characteristic master and the segment characteristic.

23. A non-transitory computer-readable medium storing software comprising instructions executable by one or more computers which, upon such execution, cause the one or more computers to perform operations comprising:
collecting sales information associated with customers regarding product purchases made by the customers and storing the sales information in a database;
clustering the customers into multiple customer segments based on the collected sales information;
calculating product purchase rates per product group for the multiple customer segments based on the collected sales information;
calculating a characteristic factor representing a correlation between a product characteristic and a customer characteristic based on the customer segments and the calculated product purchase rates;
storing the characteristic factor in the database in association with at least one product and at least one customer segment;
obtaining a target customer segment; and
suggesting a recommended product or recommended product group based on the stored characteristic factor and the obtained target customer segment.

24. The medium of claim 23, wherein clustering the customers into multiple customer segments based on the collected sales information comprises:
clustering the customers into a first set of customer segments representing different lifestyles based on collected sales information using non-hierarchy clustering; and
clustering the customers into the multiple customer segments comprising a second set of fewer customer segments representing different lifestyles based on the clustered first set of customer segments using hierarchy clustering.

25. The medium of claim 24, wherein clustering the customers into a first set of customer segments representing different lifestyles based on collected sales information using non-hierarchy clustering comprises:
classifying the customers into a first number of types of segments in a first stage using k-means clustering as the non-hierarchy clustering.

26. The medium of claim 24, wherein clustering the customers into a second set of fewer customer segments representing different lifestyles based on the clustered first set of customer segments using hierarchy clustering comprises:
further classifying the first number of types of the classified segments into a second number of types of the segments less than the first number of types in the second stage using Ward's method as the hierarchy clustering.

27. The medium of claim 23, comprising:
adding attribute parameters corresponding to the product characteristic to product data to create a product characteristic master including factor scores for the product characteristic for each product in the product group based on the calculated characteristic factor; and
counting and creating a segment characteristic including factor scores for the customer characteristic for each customer in a customer segment based on the product characteristic master and the calculated characteristic factor.

28. The medium of claim 23, comprising performing re-clustering using the segment characteristic.
